(19) United States
(12) Patent Application Publication
(10) Pub. No.: US 2016/0033263 A1
(43) Pub. Date: Feb. 4, 2016

(54) Measurement device for the three-dimensional optical measurement of objects with a topometric sensor and use of a multi-laser-chip device

(71) Applicant: GOM Gesellschaft fuer Optische Messtechnik mbH, Braunschweig (DE)

(72) Inventors: Mladen GOMERCIC, Braunschweig (DE); Alexander SCHMITLEIN, Braunschweig (DE); Tim EVERS, Braunschweig (DE); Michael JOERCK, Braunschweig (DE)

(21) Appl. No.: 14/814,547

(22) Filed: Jul. 31, 2015

(30) Foreign Application Priority Data
Aug. 1, 2014 (DE) 10 2014 110 960.0

(51) Int. Cl. G01B 11/25; G06T 17/00; G06T 7/00

(52) U.S. Cl. CPC G01B 11/25; G06T 7/0083; G06T 7/0051; G06T 17/00; G06T 2207/10021; G06T 2207/10024; G06T 2207/10028; G06T 2207/20068

(57) ABSTRACT

A measurement device for the three-dimensional optical measurement of objects with a topometric sensor includes at least one projection unit for projecting a pattern onto an object and at least one image recording unit for recording the pattern that is scattered back from the object. The projection unit has a laser-light source and a pattern generator to which the laser light radiation from the laser-light source can be supplied. The laser-light source has at least one multi-laser-chip device having a plurality of laser diode chips in a common multi-laser-chip package, wherein the laser diode chips are attached to a mounting surface of the multi-laser-chip package and are in thermal communication with the multi-laser-chip package via the mounting surface.

### FIELD OF THE INVENTION

The invention relates to a measurement device for the three-dimensional optical measurement of objects with a topometric sensor, which comprises at least one projection unit for projecting a pattern onto an object and at least one image recording unit for recording the pattern that is scattered back from the object, wherein the projection unit has a laser-light source and a pattern generator to which the laser light radiation from the laser-light source can be supplied.

The invention furthermore relates to the use of a multi-laser-chip device which has a plurality of laser diode chips in a common multi-laser-chip package.

### BACKGROUND

The three-dimensional optical capturing of object surfaces using optical triangulation sensors according to the principle of topometry is widespread in metrology. The method is based on the projection of patterns onto the object to be measured. The scattered-back pattern is recorded by one or more image recording units and subsequently evaluated by an image evaluation unit.

The patterns projected by the projection unit can have various configurations. Typical projected patterns are stochastic or deterministic patterns (for example point and stripe patterns). Stripe patterns in particular have become established as a typical pattern in optical 3D measurement for example on account of the generally simple evaluation.

Owing to the projected pattern, an artificial, temporary texture is produced on the object to be measured. Said texture is recorded by at least one image recording unit. On the basis of the artificially produced texture which is generally known a priori, illuminated 3D points can be uniquely identified on the object to be measured both in the projection unit and the one or more image recording units.

Following the measurement, the 3D coordinates can be determined by a triangulation method. This assumes that the same object point was measured in at least two spatially different recording positions. The projection unit can here act as an inverse camera such that measurement with one camera is sufficient to determine the 3D coordinates. Many topometric systems, however, use a plurality of cameras to capture the projected texture. The projection unit can in that case advantageously act merely as a texture provider, and is not taken into consideration in the 3D point calculation. As a result, the accuracy of the calculated 3D points generally increases since the mechanical and thermal stability of cameras can be realized significantly more easily.

The projection unit comprises a plurality of key components so as to be able to project patterns onto the object to be measured. These are, in particular, the illumination unit and the pattern generator. The projection unit furthermore contains projection optics which project the pattern onto the object to be measured in accordance with the configuration of the projection optics.

The illumination unit provides electromagnetic radiation. Depending on the configuration of the illumination unit, electromagnetic radiation with characterizing properties is produced. Said characterizing properties are in particular the wavelength range in which the light source emits radiation and the output.

The pattern generator imparts a pattern onto the radiation provided by the illumination unit such that, depending on the embodiment, at least one stochastic and/or defined deterministic texture can be projected onto the object to be measured using the projection optics.

Topometric sensors operate by and large in the range of visible light. Among them, systems exist that use the entire spectrum of visible light (white light) and those that use individual narrowband ranges (for example red, green or blue light). Previously known are also systems that operate in the near-infrared or in the ultraviolet range.

The use of a broadband range, for example of the entire visible spectrum, is associated with a number of disadvantages. For example, the light components are refracted differently as a function of their wavelength when transitioning from one medium into another. This results in the original signal spreading out into its individual spectral components. Corresponding media transitions, for example from air to glass, occur both in the projection optics of the projector and in the imaging optics of the image recording unit. The resulting projection defect and/or imaging defect is also referred to as chromatic aberration. The use of an appropriate lens design can reduce such imaging defects to some extent. However, doing so typically entails higher costs. In addition, systematic residual imaging defects remain despite optimization, in particular in the case of optics with short focal lengths.

Another disadvantage when using broadband radiation in order to project patterns is the influence of extraneous-light sources. Depending on the type of pattern projection and evaluation process, extraneous light results in a worsening of the signal-to-noise ratio up to a systematic falsification of the pattern evaluation. For example, the radiation that is received from an extraneous-light source that emits temporally constant radiation in the sensitive region of the image recording units reduces the useful dynamic range thereof. Fewer differentiating levels (gray levels) thus remain for the actual signal detection and signal evaluation. In common phase-shifting methods, in which at least three stripe images that are offset relative to one another are projected, this results in a smaller maximally possible modulation (amplitude) of the received stripe signal, as a result of which the phase evaluation and the 3D points which are subsequently derived therefrom are subject to a greater amount of noise. If, in phase-shifting methods, the extraneous-light source emits temporally variable radiation which is received by the image recording units involved, this leads to a systematically false phase evaluation and subsequently to systematically false 3D points.

In order to reduce the influence of chromatic aberration and extraneous-light sources, it is possible to use for example bandpass filters for the receiving optics of the image recording units. These transmit light only in a specific wavelength range, while all other light components are reflected or absorbed. With this measure, however, the power of the light source that is useful for the measurement, however, is possibly very strongly limited, as long as a broadband light source continues to be used. So as to be able to utilize the maximum portion of the output power for the actual measurement and to keep the environmental light influence to a minimum, a radiation source is necessary that generates originally narrowband light with high output. In addition, a high light output makes possible short exposure times. As a result, the topometric system is robust with respect to the relative movements between the topometric sensor and the object to be measured. Objects having a reflection behavior that is unfavorable for the measurement methods (for example directed reflection, dark objects) can furthermore also be measured in this way. In addition it is possible, depending on the configuration of the sensor, to increase the working distance from the measurement object or the measurement volume.

In addition to the object of using a narrowband light source, further properties are useful for being able to optimize the use of the light source within a projection unit. For example, the light source must provide a sufficiently high output to enable short exposure times and to reduce the influence of relative movements. Outputs of greater than or equal to 7 W (radiometric flux), for example, are desirable to ensure sufficiently strong illumination of the object to be measured in the industrial environment. Furthermore, the light source should be relatively small and compact so that the overall dimensions of the projection unit and subsequently of the topometric sensor do not become too large.

Previously known are diverse light sources of different types that can be used in a projection unit. Among them are, for example, halogen lamps, short-arc lamps, metal vapor lamps and light emitting diodes. Previously known is also the use of a laser in a projection unit. In the latter case, light is generated by stimulated emission. Owing to how the laser radiation is generated, it is characterized by a plurality of characteristic properties, which light of the previously mentioned sources generally does not possess. For example, the laser generates coherent radiation, that is to say radiation of the same phase position. In addition, the emitted radiation lies within a narrow frequency band. This is also referred to as monochromatic or narrowband light. The emitted dominant wavelength here depends on the active medium (for example helium neon laser: 632.8 nm).

A laser-light source having a defined dominant wavelength is very well suited in principle owing to its narrowband spectrum. In terms of design, it can have various configurations, for example as a solid-state laser, chemically pumped laser, laser diode etc. However, many forms of configuration are not suitable for use as a laser-light source in a topometric sensor. For example, the laser-light source needs to be as compact as possible so that the overall dimensions of the topometric sensor likewise remain as small as possible. In addition, the laser-light source needs to be as lightweight as possible, so that the mobility and the possible uses of the topometric sensor (for example topometric measurements where the user holds the topometric sensor) are not too severely limited. In addition, the financial costs for the laser source and further components for beam collimation in the topometric sensor and cooling and energy supply need to be as low as possible so that the overall costs for production of the topometric sensor do not increase disproportionately.

Solid-state lasers and chemically pumped lasers, for example, are not suitable for use in a mobile topometric sensor owing to their large volume, their large masses, the high prices and their high requirements with respect to cooling. By contrast, a laser diode in principle meets the requirements, since it is lightweight, compact and very cost efficient. However, current laser diodes that emit light in the visible spectrum have, despite comprehensive research and development in recent years, oftentimes achieved a maximum power of only up to 3 W (radiometric flux). In order to make available a light source with sufficient power in correspondence with the object, the aim is to combine a plurality of laser diodes of preferably the same type (and thus the same dominant wavelength) in a common light source.

If the intention is to combine a plurality of laser diodes into a common light source, it is desired with respect to their purpose of use within a projection unit that they are arranged in a neighboring fashion within a narrow space. This facilitates the beam guidance or focusing of the laser light in the remaining beam path within the projection unit. In addition, it permits construction of a compact projection unit. However, the problem then is the great amount of heat that develops as a byproduct of laser-light generation. As a consequence, the temperatures of the laser diodes involved increase. With correspondingly closer spacing, they heat up correspondingly more strongly. A temperature increase, however, leads to a higher power loss and thus to a lower light output per laser diode. In order to keep the operating temperature of the involved laser diodes if possible within the optimum range, sufficiently good cooling must therefore be ensured. The cooling must be greater if a greater number of laser diodes are used and if these are arranged more closely together.

As the number of laser diodes implemented in such a laser diode apparatus grows, the optical output power per laser diode drops, since the laser diodes heat one another to such an extent that the electro-optical efficiency decreases disproportionately.

For eliminating the disadvantage of conventional laser diode apparatuses, for example in a so-called TO package (TO=transistor outline), which have a relatively poor thermal communication between the laser diodes and the package and thus the environment, DE 10 2012 103 257 A1 suggests a laser diode apparatus having a package and a plurality of laser diode chips mounted on a mounting surface in a cavity of the package. In each case a heat-conducting element is arranged between the mounting surface and the laser diode chip.

### SUMMARY

It is the object of the present invention to provide an improved measurement device for the three-dimensional measurement of objects with a topometric sensor, which has a sufficiently high light output and simultaneously a low constructional size.

Suggested for a generic measurement device is the use of a laser-light source having at least one multi-laser-chip device which has a plurality of laser diode chips in a common multi-laser-chip package, wherein the laser diode chips are attached to a mounting surface of the multi-laser-chip package and are in thermal communication with the multi-laser-chip package via the mounting surface.

The multi-laser-chip device, which is described theoretically in the above-mentioned DE 10 2012 103 257 A1 and is offered for use in overhead projectors, has proven suitable and particularly advantageous for use in a topometric sensor of a measurement device for the three-dimensional optical measurement using pattern projection. It has been recognized that this novel form of construction of a laser-light source is particularly suitable as regards the required light output and a light spectrum that is as narrow as possible in order to project, using a pattern generator of a topometric sensor, patterns onto an object with sufficient light intensity and precision while ensuring sufficient heat dissipation. The so-called multi-laser-chip device, which is also referred to as “multi-die laser package”, has a large number of laser diodes arranged in a narrow space, wherein the large amount of thermal energy which is produced during operation of the laser diodes is dissipated with relatively short paths from the direct environment of the laser diodes on account of a novel arrangement and configuration of the devices, in particular of the laser diodes and their thermal communication with the package.

A particularly high optical output power simultaneously with a very compact construction is achieved by way of a series of design measures and conceptual measures. For example, the laser diodes, i.e. the laser diode chips, are arranged on the mounting surface of the package and can therefore thermally communicate very well with the package. As a result, the waste heat produced during operation can be efficiently conducted away from the laser diode chips.

It is particularly advantageous if the multi-laser-chip device has at least one heat-conducting element that is arranged between the mounting surface of the multi-laser-chip package and the at least one laser diode chip. The heat-conducting element serves in particular for spreading the flow of heat, which is produced during operation of the at least one laser diode chip, between the at least one laser diode chip and the mounting surface. This achieves a large transitional surface from the at least one laser diode chip to the multi-laser-chip package.

The multi-laser-chip package can in that case be connected preferably by its mounting surface with a suitable heat sink such that heat from the at least one laser diode chip can be effectively conducted away. On account of the fact that the waste heat is distributed by the at least one heat-conducting element over a particularly large surface area of the mounting surface and that heat is transferred from here via a relatively short heat-conducting path to the environment, it is possible for a large number of laser diode chips to be arranged in a structurally close arrangement within a multi-laser-chip package without the optical power of the individual laser diode chips being reduced due to mutual heating.

The number of the laser diode chips used can be varied such that a sufficiently strong optical power of the laser diode apparatus is achieved. In the case of a correspondingly large number of laser diode chips, it is recommended to use a correspondingly larger multi-laser-chip package in which the spacings between neighboring laser diode chips practically remains identical as compared to an embodiment with fewer laser diode chips.

It can furthermore be advantageous for each laser diode chip to be fixed to a dedicated heat-conducting element. Among others, this permits easier mounting since the respective laser diode chip can be attached in a first step to the associated dedicated heat-conducting element and subsequently one or more assemblies of laser diode chip and heat-conducting element can be attached together to the mounting surface of the multi-laser-chip package.

It can furthermore be advantageous for the multi-laser-chip package to be configured as a so-called butterfly package. In deviation from a conventional butterfly package, the package comprises a cover element which terminates the package cavity at the package's upper side (that is to say the side opposite the mounting side) and the cover element comprises a window element through which the optical radiation generated by the at least one laser diode chip can be emitted to the outside. The window element is here at least partially, preferably completely transparent for the radiation emitted by the at least one laser diode chip. Furthermore, the cover element can optionally contain a diffusing element and/or at least one lens element which diffusely scatter the light radiation of the at least one laser diode chip and/or effect beam shaping. The cover element can optionally have not only a window region, but it is also possible for each individual laser diode chip to emit the light radiation it produces through a dedicated window element. The window elements are component parts of the cover element and can have multifarious configurations. For example, the window elements can be configured as beam-shaping elements, for example as scatter diffusing and/or lens elements.

The laser diode apparatus preferably has at least one deflection element which deflects the optical radiation provided by at least one laser diode chip in the direction of the window element.

The laser diode chips, however, can also be arranged such that the light is emitted directly in the emission direction, that is to say is emitted perpendicular to the mounting plate. In this case, no deflection element is necessary. One practical design of a multi-laser-chip device in which the laser diode chips are arranged perpendicular to the mounting plate and the light is emitted without deflection element directly perpendicular to the mounting plate is the laser chip device having the type designation “PLPM4 450” by OSRAM Opto Semiconductors GmbH.

The multi-laser-chip devices permit the use of two or more such multi-laser-chip devices next to one another in one projection unit so as to further increase in this way the achievable optical output power of topometric sensors with manageable cooling problems.

A further advantage of the so-called “multi-die laser package” construction is the very simple installation and removal of the laser diode apparatus in the projection unit. In addition, the installation and adjustment of such laser-light sources causes significantly less work then a large number of conventional laser diode apparatuses (for example of the TO construction type).

### DESCRIPTION OF THE DRAWINGS

The invention will be explained in more detail below with reference to exemplary embodiments using the appended drawings, in which the figures show:

FIG. 1—a diagram of a measurement device for the three-dimensional optical measurement of objects with a multi-laser-chip device with a plurality of laser diode chips;

FIG. 2a—a diagram of a multi-laser-chip device having 25 laser chip diodes in plan view;

FIG. 2b—a diagram of a multi-laser-chip device having 25 laser chip diodes in a perspective oblique illustration.

### DESCRIPTION

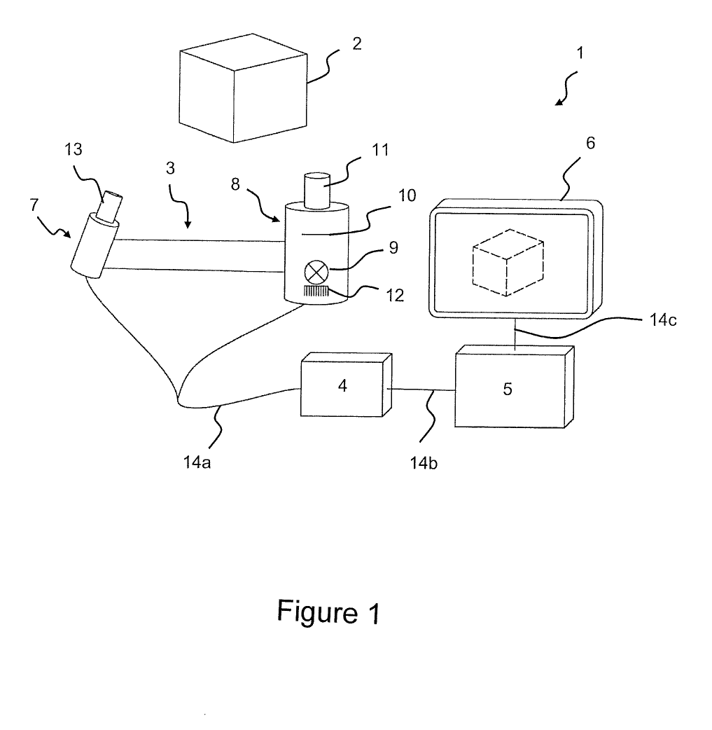

FIG. 1 shows a measurement device 1 for the three-dimensional optical measurement of objects 2. The measurement device 1 has a topometric sensor 3, a control unit 4 (known per se) for controlling the topometric sensor 3, an evaluation unit 5 (known per se) for the topometric evaluation of the images of the object 2 recorded by the topometric sensor 3, and a display unit 6. The topometric sensor 3 has the original task of projecting at least one pattern onto the object 2 to be measured and to record the signal of the at least one projected pattern that is scattered back from the object 2 using at least one image recording unit 7 of the topometric sensor 3. The projection of the at least one pattern is carried out using a projection unit 8.

The projection unit 8 consists substantially of an illumination device configured as a laser-light source 9, a pattern generator 10 and projection optics 11. The projection unit 8 is adapted such that stochastic and/or deterministic patterns can be generated and projected onto the object 2 to be measured. The laser-light source 9 is formed from at least one multi-laser-chip device (also referred to as a multi-die laser package). Such a multi-laser-chip device comprises a defined multiplicity of laser diode chips, such as for example a number of 25 laser diode chips. The thermal waste heat can be dissipated from the direct surroundings of the laser diodes owing to the arrangement and configuration of the laser diode chips and their thermal communication with the multi-laser-chip package. The laser-light source 9 with its at least one multi-laser-chip package is advantageously fixed to a heat sink 12. The thermal waste heat generated by the laser diode chips during operation is spread over at least one heat-conducting element and transferred over a short path to the package of the laser-light source 9, in particular the package underside, and output here to the surroundings via the heat sink 12. As a result, the optical power of the associated laser diode chips does not drop significantly back below the nominal power thereof, since the temperature of the laser diode chips does not increase strongly owing to the effective cooling.

The laser light from the laser-light source 9 is conducted to the pattern generator 10. In the present exemplary embodiment, the pattern generator 10 is configured as a digital micromirror device (DMD). In practice, the use of a digital micromirror device as a pattern generator 10 has proven useful. It substantially consists of a surface light modulator, which is formed from micromirror actuators arranged in the form of a matrix, that is to say tiltable reflective surfaces. The orientation of the large number of individually movable mirrors is individually adaptable via digital control and two states of orientation per mirror are possible.

The pattern generator 10 can also have a different configuration. For example, analog transparency elements (for example made of glass) having one or more fixed patterns can be used. In addition, it is possible for the at least one transparency element to be set into motion with respect to the light source (for example rotation and/or translation). Furthermore, other programmable displays such as liquid-crystal-on-silicon (LCOS) or liquid-crystal display (LCD) could also be used.

The laser light that is subjected to the pattern to be projected by the pattern generator 10 is projected through the projection optics 11 onto the object 2. The light components that are reflected from the object 2 are recorded by the image recording unit 7 via receiving optics 13 in the form of one or more 2D images.

The topometric sensor 3 is controlled by a controller 4. The recorded image data of the image recording unit 7 and the projected pattern data are evaluated by an image evaluation unit 5. The results are represented by a display unit 6. The data is transferred between the individual components through a suitable cable connection 14a-14c.

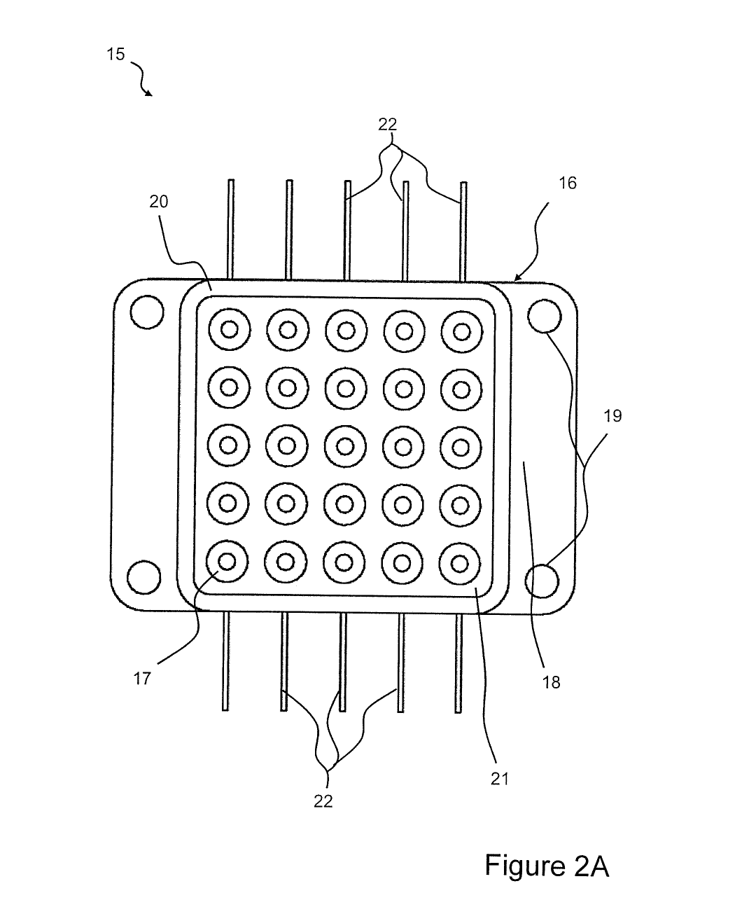

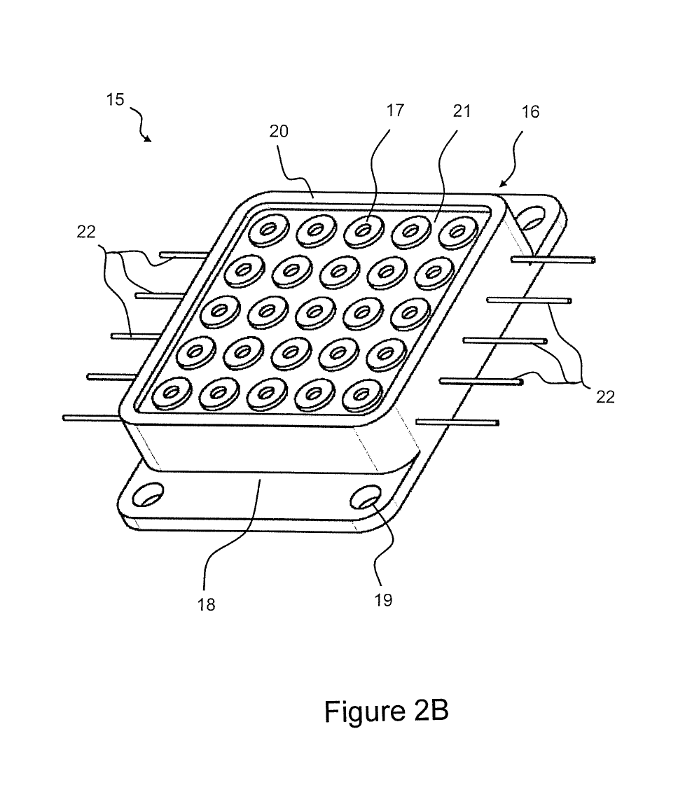

FIG. 2a-b shows a schematic illustration of a preferred embodiment of the laser-light source 9, which is configured as a multi-laser-chip device 15, in plan view (FIG. 2a) and a perspective oblique illustration (FIG. 2b).

In the illustrated exemplary embodiment, the laser-light source 9 has a multi-laser-chip device 15 (also referred to as multi-die laser package) having a multi-laser-chip package 16. It comprises a defined multiplicity of laser diode chips 17, for example a number of 25 laser diode chips 17. The thermal waste heat can be dissipated from the direct surroundings of the laser diode chips 17 owing to the arrangement and configuration of the devices, in particular of the laser diode chips 17, and their thermal communication with the multi-laser-chip package 16. The multi-laser-chip package 16 of the laser-light source 9 is advantageously fixed to a heat sink 12. The thermal waste heat generated by the laser diode chips 17 during operation is spread over at least one heat-conducting element, which is arranged between the laser diode chips 17 and a mounting surface 18 of the multi-laser-chip package 16, and transferred over a short path to the multi-laser-chip package 16 of the laser-light source 9, in particular to the package underside, and output here to the surroundings via the heat sink 12. As a result, the optical power of the associated laser diode chips 17 does not drop significantly back below the nominal power thereof, since the temperature of the laser diode chips 17 does not increase strongly owing to the effective cooling. The multi-laser-chip package 16 comprises mounting sections 19, with which the laser-light source 9 can be mechanically connected to the heat sink 12.

The multi-laser-chip package 16 is configured in the form of a butterfly package. It has a circumferential collar 20 which projects from the mounting surface 18 and forms a cavity in which the laser diode chips 17 are introduced. The beam exit side of the cavity is closed off with a cover element 21 which is transparent at least in the region of the beam exit of the individual laser diode chips 17 (at least light-transmissive for the peak wavelength of the emitted laser light).

Control of the laser diode chips 17 is effected via metallic pins 22 or connection surfaces or the like, which are arranged for example on two opposite sides of the package respectively.

1. A measurement device for the three-dimensional optical measurement of objects with a topometric sensor, comprising:
at least one projection unit for projecting a projection pattern onto an object;
at least one image recording unit for recording a scattered pattern that is scattered back from the object,
wherein the projection unit has a laser-light source and a pattern generator to which laser light radiation from the laser-light source is supplied,
wherein the laser-light source has at least one multi-laser-chip device having a plurality of laser diode chips in a common multi-laser-chip package, wherein the laser diode chips are attached to a mounting surface of the multi-laser-chip package and are in thermal communication with the multi-laser-chip package via a mounting surface.

2. The measurement device according to claim 1, wherein the multi-laser-chip device comprises at least one heat-conducting element which is arranged between the mounting surface of the multi-laser-chip package and the laser diode chips.

3. The measurement device according to claim 1, wherein the laser-light source has two or more multi-laser-chip devices which are arranged next to one another and are coupled to one another.

4. The measurement device according to claim 1, further comprising an image evaluation unit which is adapted for topometric evaluation of the images recorded with the at least one image recording unit, with pattern elements scattered back from the object for optically measuring the object.

5. The measurement device according to claim 1, wherein the pattern generator is configured as a digital micromirror device.

6. The measurement device according to claim 1, wherein the at least one multi-laser-chip package is connected by its mounting surface to a heat sink arranged outside the multi-laser-chip package.

7. A method for the three-dimensional optical measurement of objects, comprising the steps of:
using a multi-laser-chip device which has a plurality of laser diode chips in a common multi-laser-chip package, wherein the laser diode chips are mounted on a mounting surface of the multi-laser-chip package and thermally communicate with the multi-laser-chip package via the mounting surface, as a laser-light source of a projection unit of a topometric sensor to project at least one projection pattern onto an object; and
recording the object together with at least one scattered back pattern that is scattered back from the object.

8. The method of claim 7, wherein the multi-laser-chip device comprises at least one heat-conducting element which is arranged between the mounting surface of the multi-laser-chip package and the laser diode chips.

9. The method according to claim 7, wherein the laser-light source has two or more multi-laser-chip devices which are arranged next to one another and are coupled to one another.

10. The method according to claim 7, further comprising the step of generating the projection pattern with at least one digital micromirror device as pattern generator.
